(19) United States
(12) Patent Application Publication
(10) Pub. No.: US 2024/0117799 A1
(43) Pub. Date: Apr. 11, 2024

(54) APPARATUS FOR PUMPING SUSPENDED POLYMER LIQUID

(71) Applicant: ChampionX LLC, Sugar Land, TX (US)

(72) Inventors: Kerry Charles Brinkman, Sugar Land, TX (US); Chad Gilmer, Richmond, TX (US); Anoop Chengara, Iowa Colony, TX (US); Michael Cash, Richmond, TX (US); Rogelio Banda, Houston, TX (US); Tri T. Phan, Sugar Land, TX (US); Nicholas Wiewiorowski, Sugar Land, TX (US)

(21) Appl. No.: 18/482,259

(22) Filed: Oct. 6, 2023

Related U.S. Application Data
(60) Provisional application No. 63/378,626, filed on Oct. 6, 2022.

(51) Int. Cl. F04B 15/00; C09K 8/524; F04B 19/22

(52) U.S. Cl. CPC F04B 15/00; C09K 8/524; F04B 19/22; C09K 2208/28

(57) ABSTRACT

The present disclosure is generally directed to an apparatus for pumping suspended polymer liquids that reduces the formation of polymeric deposits at the seal contact surfaces and filters out deposits that do form. This allows for an oil drag reducing agent (DRA) to be delivered continuously from topside through an umbilical to subsea produced fluids flowlines to increase oil production and/or flow of gas/oil by reducing friction loss due to turbulent flow in the flowlines.

### CROSS REFERENCE TO RELATED APPLICATIONS

This patent application claims the benefit of U.S. Provisional Patent Application No. 63/378,626, filed Oct. 6, 2022; the entire disclosure of which is incorporated herein by reference.

### FIELD

The present disclosure provides an apparatus for pumping suspended polymer liquids that reduces the formation of polymeric deposits at the seal contact surfaces and filters out deposits that do form. This is accomplished by employing a second compatible, consumable non-deposit-forming liquid to exclude the suspended polymer liquid from these seal contact surfaces. The second liquid forms a thin coating on sliding surfaces to displace and exclude the suspended polymer liquid from the high shear and friction at the seal contact points. This allows for an oil drag reducing agent (DRA) to be delivered continuously from topside through an umbilical to subsea produced fluids flowlines to increase oil production and/or flow of gas/oil by reducing friction loss due to turbulent flow in the flowlines.

### BACKGROUND

Solving the problem of agglomeration and deposit formation when pumping suspended polymer liquids has been the subject of many patents. For example, U.S. Pat. No. 9,644,161 discloses that the incorporation of plasticizers into the solid polymer particles helped to reduce deposits in pumps. The plasticizer described in the patent example was 2-ethylhexanol at 10% of the formulation. In another example, diesters and triesters of diols and polyols were disclosed in U.S. Pat. No. 10,053,595 as additives to improve drag reducer injection. The improvement constitutes a decrease in film formation in the pump head that can interfere with pumping of the DRA emulsion. Likewise, U.S. Pat. No. 9,939,113 describes the addition of kerosene, heptane and isooctane to emulsion formulations at 3 to 30% to reduce deposit formation in pumps. In US Patent Application 2016/0326394A1, core-shell suspended polymer liquids are disclosed for use in DRA applications. The amphiphilic shell applied in a second polymerization step is intended to reduce film-forming tendencies of the core polymer. U.S. Pat. No. 8,215,930 discloses the use of barrier materials applied to surfaces in diaphragm pumps to reduce deposit formation caused by emulsions and the subsequent blockage of check valves. U.S. Pat. No. 8,656,950 describes a method for applying latex DRA by pressurizing the latex in a pressure vessel and injecting it into a pipeline to avoid deposit formation when pumping the latex.

Many pumps, especially those designed to achieve high pressures, employ a reciprocating piston or plunger to achieve the pumping action. These pumps require seals to contain and propel the liquid. The vast majority of seals are formed from elastomeric materials. Unfortunately, some common elastomers appear to facilitate the agglomeration of the suspended polymer particles into larger masses where the seal contacts a sliding surface. The sliding surface may be a plunger or piston rod reciprocating through a packing gland seal or a piston seal reciprocating within a cylinder bore. The resulting polymer deposits can act to erode the seal and, when they are dislodged, foul the check valves and down-stream applications.

The DRA application calls for pumping suspended polymer liquid through a long umbilical tube at up to 20,000 psi. Previous modifications to the suspended polymer chemistry reduced, but did not eliminate, the formation of polymer deposits in the sliding contact surfaces. These deposits cause operability problems that must be solved prior to product commercialization. No commercially available pump exists that can pump the suspended polymer liquid at these pressures without forming deposits.

Pneumatic plunger pumps are commonly used on offshore platforms to pump additives down an umbilical. With DRA suspended polymer liquids, polymer particle aggregation occurs at the intersection of the plunger and the elastomer seal to form deposits that create major operability problems. Elastomer may be acting as a catalytic surface to facilitate binding of the sticky particles.

### SUMMARY

The present disclosure provides an apparatus for pumping suspended polymer liquid comprising a pump containing a separate non-deposit-forming liquid to exclude the suspended polymer liquid from contact with elastomeric sealing surfaces within the pump.

The disclosure describes a pump comprising a pump head 1, the pump head 1 comprising a cylinder 5 having a piston 20 disposed therein, wherein the piston 20 separates the cylinder 5 into a first volume 8 and a second volume 10; a rod 22 connected to the piston 20 and through packing gland 24 to a motor; a suspended polymer liquid inlet 12 in fluid communication with the first volume 8 of the cylinder 5; a first inlet valve 2 in the suspended polymer liquid inlet 12 and upstream from the first volume 8 capable of controlling the flow of aft suspended polymer liquid into the first volume 8; an suspended polymer liquid outlet 14 in fluid communication with the first volume 8 of the cylinder 5; a first outlet valve 4 in the suspended polymer liquid outlet 14 capable of controlling the flow of the suspended polymer liquid; a non-deposit-forming liquid inlet 16 in fluid communication with the second volume 10 of the cylinder 5; a second inlet valve 6 in the non-deposit-forming liquid inlet 16 and upstream from the second volume 10 capable of controlling the flow of the non-deposit-forming liquid into the second volume 10; a non-deposit-forming liquid outlet 18 in fluid communication with the second volume 10 of the cylinder 5; a second outlet valve 9 in the non-deposit-forming liquid outlet 18 capable of controlling the flow of the non-deposit-forming liquid; wherein the non-deposit-forming liquid outlet 18 is in fluid communication with the non-deposit-forming liquid inlet 16.

The disclosure is also directed to a method for pumping a suspended polymer liquid comprising circulating a non-deposit-forming liquid from a liquid vessel through a liquid inlet 16 and a second inlet valve 6 to a second volume 10 of a cylinder 5, out a liquid outlet 18 through a second outlet valve 9 and back to liquid inlet 16; circulating a suspended polymer liquid from a suspended polymer liquid vessel through a suspended polymer liquid inlet 12 through a first inlet valve 2 into a first volume 8 of the cylinder 5, out a suspended polymer liquid outlet 14 through a first outlet valve 4 and into a conduit comprising a flowing hydrocarbon fluid or flowing aqueous fluid; and moving the piston 20 to change the relative volumes of the first volume 8 and second volume 10 in order to effect the circulation of the non-deposit-forming liquid and the suspended polymer liquid.

Other features, objects, and advantages of the disclosure will be apparent from the description and drawings, and from the claims.

### BRIEF DESCRIPTION OF THE DRAWINGS

FIG. 1 depicts a schematic of a pump head for a double action piston pump.

FIG. 2 depicts a schematic of a pump head for a double action piston pump including a filter for the suspended polymer liquid at the suspended polymer liquid outlet.

FIG. 3 depicts a schematic of a pump head for a double action piston pump including a filter for the suspended polymer liquid at the suspended polymer liquid outlet and a heat exchanger for the polymer emulsion at the polymer emulsion inlet.

Corresponding reference characters indicate corresponding parts throughout the drawings.

### DETAILED DESCRIPTION

The present disclosure is directed to a pump and filtration system that minimizes the formation of polymer deposits during pumping of suspended polymer liquid. The pump and filtration system that reduces deposit formation when pumping suspended polymer liquid and removes deposits that do form. The preferred pump design consists of two pumping chambers connected by a cylinder in which a piston reciprocates and provides pumping action to both chambers alternately. The piston is driven by a piston rod that reciprocates through a packing gland seal integral to one of the chambers. The gland seal is usually comprised of a stack of V-seals in a chevron configuration. The chamber to which the packing gland is integral is closest to the pneumatic or electric motor that drives the reciprocating motion. An example of this type of pump is the CheckPoint 5400 and 8400 series of pneumatic pumps. The pump can be the CheckPoint 8412 pump. The seal material of the packing gland seal may be of any common elastomer that is effective at containing high pressure and is compatible with the liquid being pumped.

The disclosure describes a pump apparatus comprising a pump head 1, the pump head 1 comprising a cylinder 5 having a piston 20 disposed therein, wherein the piston 20 separates the cylinder 5 into a first volume 8 and a second volume 10; a rod 22 connected to the piston 20 and through packing gland seal 24 to a motor; a suspended polymer liquid inlet 12 in fluid communication with the first volume 8 of the cylinder 5; a first inlet valve 2 in the suspended polymer liquid inlet 12 and upstream from the first volume 8 capable of controlling the flow of a suspended polymer liquid into the first volume 8; a suspended polymer liquid outlet 14 in fluid communication with the first volume 8 of the cylinder 5; a first outlet valve 4 in the suspended polymer liquid outlet 14 capable of controlling the flow of the suspended polymer liquid; a non-deposit-forming liquid inlet 16 in fluid communication with the second volume 10 of the cylinder 5; a second inlet valve 6 in the non-deposit-forming liquid inlet 16 and upstream from the second volume 10 capable of controlling the flow of a non-deposit-forming liquid into the second volume 10; a non-deposit-forming liquid outlet 18 in fluid communication with the second volume 10 of the cylinder 5; a second outlet valve 9 in the non-deposit-forming liquid outlet 18 capable of controlling the flow of the non-deposit-forming liquid; wherein the non-deposit-forming liquid outlet 18 is in fluid communication with the non-deposit-forming liquid inlet 16.

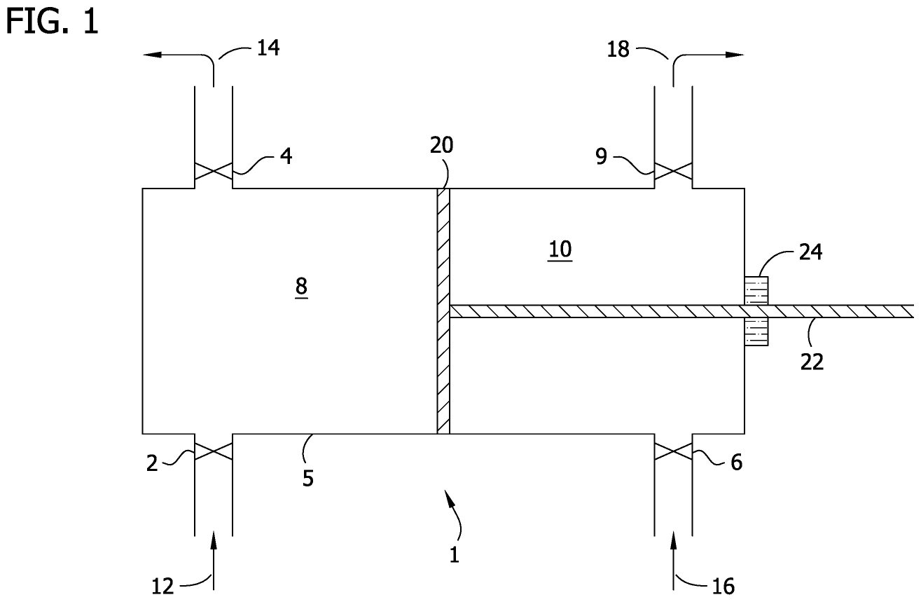

FIG. 1 also discloses the pump head described above.

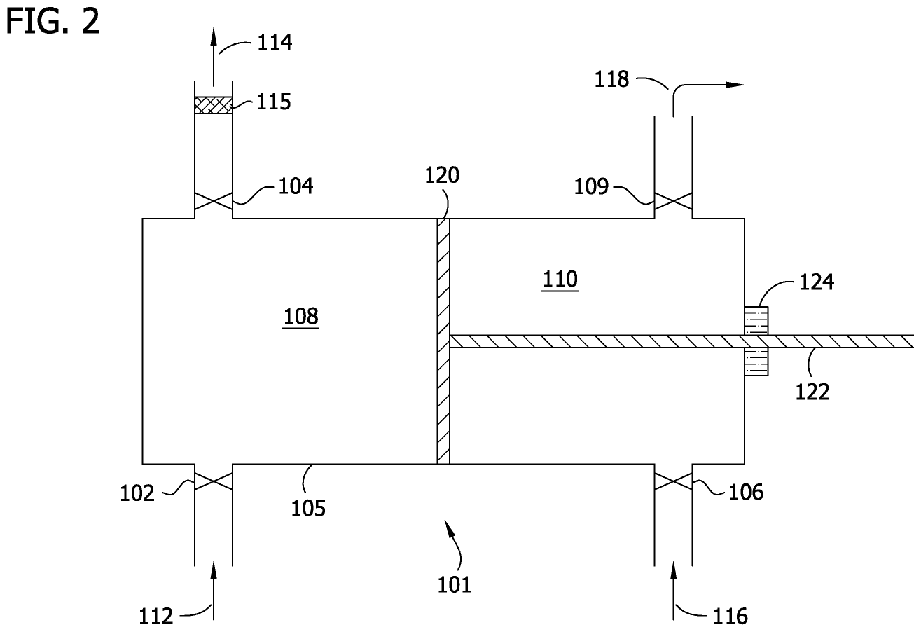

FIG. 2 is a schematic of a pump head 101 comprising a cylinder 105 having a piston 120 disposed therein, wherein the piston 120 separates the cylinder 105 into a first volume 108 and a second volume 110; a rod 122 connected to the piston 120 and through packing gland seal 124 to a motor; a suspended polymer liquid inlet 112 in fluid communication with the first volume 108 of the cylinder 105; a first inlet valve 102 in the suspended polymer liquid inlet 112 and upstream from the first volume 108 capable of controlling the flow of a suspended polymer liquid into the first volume 108; a suspended polymer liquid outlet 114 in fluid communication with the first volume 108 of the cylinder 105; a first outlet valve 104 in the suspended polymer liquid outlet 114 capable of controlling the flow of the suspended polymer liquid; an suspended polymer liquid filter 115 in the suspended polymer liquid outlet 114 downstream from the first outlet valve 104; a non-deposit-forming liquid inlet 116 in fluid communication with the second volume 110 of the cylinder 105; a second inlet valve 106 in the non-deposit-forming liquid inlet 116 and upstream from the second volume 110 capable of controlling the flow of a non-deposit-forming liquid into the second volume 110; a non-deposit-forming liquid outlet 118 in fluid communication with the second volume 110 of the cylinder 105; a second outlet valve 109 in the non-deposit-forming liquid outlet 118 capable of controlling the flow of the non-deposit-forming liquid; wherein the non-deposit-forming liquid outlet 118 is in fluid communication with the non-deposit-forming liquid inlet 116.

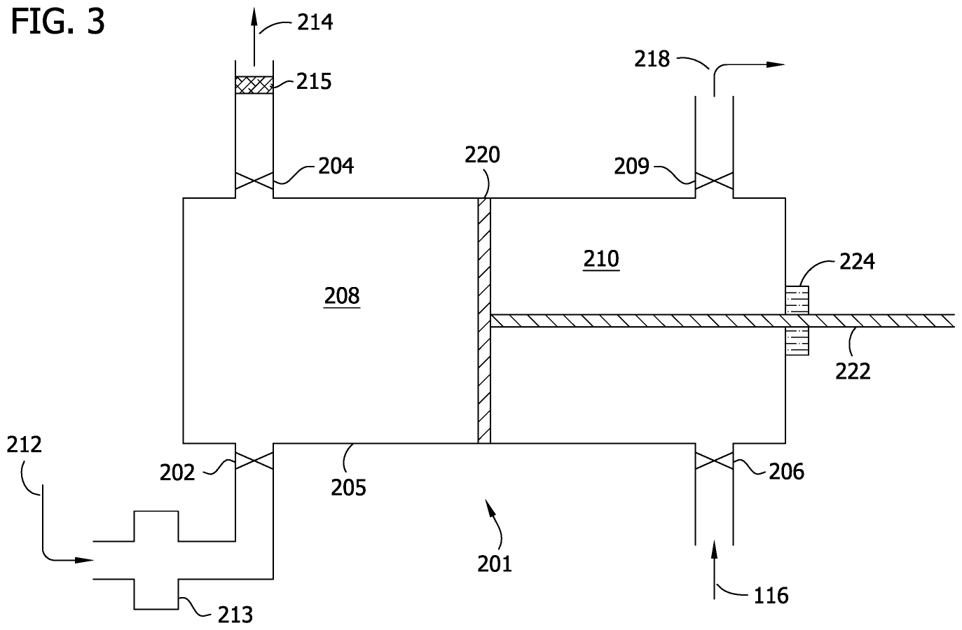

FIG. 3 is a schematic of a pump head 201 comprising a cylinder 205 having a piston 220 disposed therein, wherein the piston 220 separates the cylinder 205 into a first volume 208 and a second volume 210; a rod 222 connected to the piston 220 and through a packing gland seal 224 to a motor; a suspended polymer liquid inlet 212 in fluid communication with the first volume 208 of the cylinder 205; a heat exchanger 213 in the suspended polymer liquid inlet 212; a first inlet valve 202 in the suspended polymer liquid inlet 212 downstream from the heat exchanger 213 and upstream from the first volume 208 capable of controlling the flow of a suspended polymer liquid into the first volume 208; a suspended polymer liquid outlet 214 in fluid communication with the first volume 208 of the cylinder 205; a first outlet valve 204 in the suspended polymer liquid outlet 214 capable of controlling the flow of the suspended polymer liquid; a suspended polymer liquid filter 215 in the suspended polymer liquid outlet 214 downstream from the first outlet valve 204; a non-deposit-forming liquid inlet 216 in fluid communication with the second volume 210 of the cylinder 205; a second inlet valve 206 in the non-deposit-forming liquid inlet 216 and upstream from the second volume 210 capable of controlling the flow of a non-deposit-forming liquid into the second volume 210; a non-deposit-forming liquid outlet 218 in fluid communication with the second volume 210 of the cylinder 205; a second outlet valve 209 in the non-deposit-forming liquid outlet 218 capable of controlling the flow of the non-deposit-forming liquid; wherein the non-deposit-forming liquid outlet 218 is in fluid communication with the non-deposit-forming liquid inlet 216.

The pump apparatus described herein can have the pump head further comprise a suspended polymer liquid filter in the suspended polymer liquid outlet downstream from the first outlet valve 4.

The pump apparatus described herein can also have the pump head further comprises a heat exchanger in the suspended polymer liquid inlet upstream from the first inlet valve 2.

Further, the pump apparatus described herein can further comprise a suspended polymer liquid vessel in fluid communication with the suspended polymer liquid inlet 12.

The pump apparatus can also further comprise a non-deposit-forming liquid vessel in fluid communication with the non-deposit-forming liquid inlet 16.

The pump apparatus described herein can have the non-deposit-forming liquid vessel comprise a bag filter and housing.

Also, the pump apparatus can have the pump head further comprise a packing seal surrounding the rod 22 and connected to the cylinder 5 in the second volume 10.

Additionally, the pump apparatus can have the pump head further comprise a pressure control device between the second outlet valve and the non-deposit-forming liquid vessel.

The pump apparatus can have the piston comprise a U-cup seal.

The piston can have a side of the U-cup seal having an open channel or filled channel in contact with the first volume 8 of the cylinder.

The pump apparatus can further have the pressure control device be adjustable to allow the pressure within pump chamber that is integral with the packing seal to be varied and adjust the leakage rate of the non-deposit-forming liquid around the U-cup seal.

Additionally, the pump apparatus can have the piston contain metal or inorganic seals in front of the U-Cup seal that directly contact the suspended polymer liquid.

The pump apparatus can have the suspended polymer liquid filter has an element comprising a wire screen wrapped smoothly around a cylindrical support to remove deposits from the suspended polymer liquid.

The pump apparatus also can have the non-deposit-forming liquid comprises an emulsion of polydimethylsiloxane oil; the non-deposit-forming liquid comprises water, an alcohol, a glycol, a polyglycol, glycerin, or a combination thereof; the non-deposit-forming liquid comprises a solution of natural or modified polysaccharide in water; the non-deposit-forming liquid comprises a lipophilic compound with lubricating properties selected from a hydrocarbon oil, a fatty acid, a fatty ester, a fatty amide, a fatty alcohol, or a combination thereof; or the non-deposit-forming liquid comprises polyethylene glycol, polypropylene glycol, polyglycerin, polybutylene glycol, a glycol copolymer, a glycol terpolymer, or a combination thereof.

The pump apparatus can have particular effects, for example, (i) flow can be improved by reducing the formation of polymer deposits as compared to a pump apparatus not comprising a non-deposit-forming liquid; (ii) the non-deposit-forming liquid can be consumed slowly in operating the pump apparatus and become a component of the suspended polymer liquid; (iii) the non-deposit-forming liquid can be immiscible or miscible with the suspended polymer liquid; or (iv) the non-deposit-forming liquid can have a low viscosity relative to the suspended polymer.

Further, the disclosure is directed to a method for pumping a suspended polymer liquid comprising circulating a non-deposit-forming liquid from a non-deposit-forming liquid vessel through a non-deposit-forming liquid inlet 16 and a second inlet valve 6 to a second volume 10 of a cylinder 5, out a liquid outlet 18 through a second outlet valve 9 and back to liquid inlet 16; circulating a suspended polymer liquid suspension from a suspended polymer liquid vessel through a suspended polymer liquid inlet 12 through a first inlet valve 2 into a first volume 8 of the cylinder 5, out a suspended polymer liquid outlet 14 through a first outlet valve 4 and into a conduit comprising a flowing hydrocarbon fluid or flowing aqueous fluid; and moving the piston 20 to change the relative volumes of the first volume 8 and second volume 10 in order to effect the circulation of the non-deposit-forming liquid and the suspended polymer liquid.

The conduit comprising a flowing hydrocarbon fluid or flowing aqueous fluid can have a first conduit comprising the suspended polymer liquid and a second conduit comprising a flowing hydrocarbon fluid or flowing aqueous fluid.

The methods described herein can further comprise filtering the suspended polymer liquid suspension after it passes through the first outlet valve 4.

Also, the methods further comprise passing the suspended polymer liquid through a heat exchanger to cool the suspended polymer liquid before it passes through the first inlet valve 2.

The methods can have the non-deposit-forming liquid having lubricating properties.

The lubricating properties of the non-deposit-forming liquid can include having a viscosity greater than the viscosity of air.

The methods described herein can also have the non-deposit-forming liquid comprise water, a polydimethylsiloxane oil, an aqueous polyelectrolyte, an aqueous polysaccharide, a hydrocarbon, an alcohol, a glycol, a polyglycol, glycerin, or a combination thereof.

Additionally, the methods described herein can have the polydimethylsiloxane oil having a viscosity from about 50 to about 10,000 cPs at 23° C.

The methods can have the non-deposit-forming liquid comprise an aqueous emulsion of polydimethylsiloxane oil.

Also, the methods described herein can have the non-deposit-forming liquid comprises at least 95% water.

The suspended polymer liquid can comprise a polymer emulsion suspension.

The methods further can have the suspended polymer liquid comprise a drag-reducing polymer.

The methods also can have the conduit or first conduit be an umbilical line.

Further, the methods described herein can have the suspended polymer liquid reduce turbulence in the flowing hydrocarbon fluid or the flowing aqueous fluid within the conduit or second conduit.

Additionally, the methods can have the suspended polymer liquid flow out the suspended polymer liquid outlet and flow into a first conduit and then the suspended polymer liquid is injected into a second conduit comprising the flowing hydrocarbon fluid or flowing aqueous fluid.

Also, the methods can have the polymer in the suspended polymer liquid disperse into the flowing hydrocarbon fluid or the flowing aqueous fluid and reduce turbulence, friction, or drag in the conduit or second conduit.

In the present disclosure, the two chambers are set up to pump different fluids. Within the chamber containing the second volume 10, 110, or 210 and which is integral with the packing glad seal 24, 124, or 224 is contained a non-deposit forming liquid that is compatible with the suspended polymer liquid and has lubricating properties. The pumping action within this chamber serves to recirculate the lubricating non-deposit-forming liquid through a reservoir. Lubricating non-deposit-forming liquid is drawn into the chamber through an inlet check valve when the piston is driven forward into the cylinder towards the chamber containing volume 8, 108, and 208. The lubricating non-deposit-forming liquid is expelled through the outlet check valve when the piston reverses and is withdrawn back through the cylinder towards the chamber of volume 10, 110, or 210. An optional pressure relief valve on the outlet from the lubricant chamber can be used to apply back-pressure to the lubricating non-deposit-forming liquid within the chamber.

The chamber of volume 8, 108, or 208 contains the suspended polymer liquid that is being pumped. Suspended polymer liquid is drawn into this chamber through an inlet check valve when the piston is retracted within the cylinder towards the chamber containing the lubricating non-deposit forming liquid. The suspended polymer liquid is expelled through the outlet check valve when the piston reverses and is forced back through the cylinder towards the chamber containing the suspended polymer liquid. The seal on the piston serves to separate the suspended polymer liquid in the second chamber from the lubricating non-deposit-forming liquid in the first chamber. It is expected that some lubricant will remain on the cylinder walls to facilitate the movement of the piston, reduce erosion of the piston seal, and displace suspended polymer liquid that might otherwise form deposits.

The present disclosure is, in some ways, similar to plunger pumps that have a lubrication chamber on the back side of the packing gland seal. This lubrication feature is rare on plunger pumps and even more rarely, if ever, available with a pressurized lubrication system to force lubricant into the gland and exclude the pumped chemical. Experience has shown that static lubrication of the gland seal from the backside, while somewhat effective at reducing suspended polymer liquid deposits, does not altogether prevent deposits from forming. When suspended polymer liquid is pumped in the chamber that is integral to the packing gland seal, the pressure within the pump drives the suspended polymer liquid into the gland seal where friction and heat can agglomerate the polymer particles.

The piston seal of the present disclosure may be made of any common elastomer in any of the common seal conformations that provide an adequate seal to separate the two liquids and allow for high pumping pressure. While not restricted, common seal types include activated slide rings, O-rings, V-seals with male, female, and intermediate V-seals in a chevron configuration, single or multiple flat elastomeric washers compressed in a stack, and U-cup seals. Most preferred is a piston seal with a U-cup design with the cup channel (or filled channel) facing the suspended polymer-containing chamber. U-cup seals made of hard polyurethane are most preferred. U-cup seals are most effective at sealing when moving in the direction that the seal's channel side is facing. This orientation allows good pumping of the suspended polymer liquid as the piston moves forward. The U-cup is less effective at sealing when moving in the reverse direction away from the channel side. On the reverse stroke as the piston is withdrawn, lubricating non-deposit-forming liquid on the back side of the seal can leak around the outside edges of the seal and lay down a thin lubricant coating on the cylinder wall. The amount of lubricant applied to the cylinder surface can be regulated by the pressure maintained within the lubricating non-deposit-forming liquid chamber during the lubricant pumping stroke. A pressure relief valve on the outlet from the lubricating non-deposit-forming liquid chamber can be used to apply back-pressure to the lubricant and will affect the amount that by-passes the U-cup seal during its backward stroke. The pressure relief valve is adjusted empirically to achieve the desired consumption rate of the lubricant. The lubricating non-deposit-forming liquid is a consumable that must be replenished periodically.

A further aspect of this disclosure is the use of metallic or ceramic seals with the optional backup of elastomeric seals. Experience has shown that the rate of deposit formation is much reduced when the elastomeric seal is replaced with an inorganic or metal seal. In one example, traditional metal piston rings can be fitted in a groove around a close-fitting brass piston that reciprocates within the cylinder connecting the two pumping chambers. The piston rings are compressed inward when the piston is fitted into the cylinder and the gap in the ring is closed. The ring scrapes along the metal wall of the cylinder to form the seal and prevents suspended polymer liquid from bypassing the piston and entering the lubricating non-deposit-forming liquid chamber.

Optionally, an elastomeric seal may be placed behind the metal or inorganic seals to improve high-pressure performance. Any elastomer seal that can assist with maintaining a tight seal at high pressure may be employed behind the metal or inorganic seals. Most preferred, a U-cup seal is employed with the open channel (or filled channel) facing toward the suspended polymer liquid-containing chamber. The one-way nature of U-cup seals allows for high-pressure sealing in the forward direction while allowing some leakage around the U-cup seal and into the narrow spaces between the elastomeric seal and the metal or inorganic seals in the reverse direction of travel. By filling these voids with lubricant instead of suspended polymer liquid, lubrication is improved with reduced seal and metallic erosion and with reduced deposit formation. The metal or inorganic seals help to reduce the consumption of lubricant and improve the overall deposit-reducing performance of the hybrid seal.

The design of the piston is also important for low deposit formation. To prevent extrusion of the U-cup seal at high pressure, the gap between the piston and cylinder wall should be as small as possible. A gap of 0.0005″ to 0.01″ is desirable and with a gap less than 0.005″ being most preferred. The piston material of construction should be softer than the cylinder wall to prevent scoring. A piston constructed of brass is most preferred. The length of the piston before and after the seal location is also important. On the lubricant side of the piston, the piston length behind the seal should be from 0.1″ to 2″. Preferably, the length should be as long as possible and still fit at the maximum back-stroke of the piston rod towards the packing gland. This extra length helps to keep the piston centered in the cylinder bore and provides a maximum of surface area over which to spread contact between the piston and wall to minimize side-loading pressure.

On the suspended polymer side of the piston, the length of the piston in front of the U-cup seal should also be between 0.1″ and 2″ while still fitting within the confines of the pump chamber on the maximum forward stroke. A gap of 0.0005″ to 0.01″ between the piston and wall is also desirable in this section but this gap may differ from the gap behind the seal. The gap before the seal should be sufficient to allow some polymer deposit to accumulate and pack around the piston in this forward section. The packed deposit can act as a secondary seal to isolate the elastomeric seal from the suspended polymer liquid. The lubricant that leaks forward around the seal can fill any voids immediately in front of the seal and excludes the deposit-forming suspended polymer liquid from contact with the seal.

One advantage of this dual-chamber design is that no deposits form in the packing gland seal because it is not exposed to the suspended polymer liquid. The gland seal, which is very susceptible to deposit formation, is only exposed to the non-deposit-forming lubricating liquid and its operating lifetime is extended by benefit of the friction reducing action of the lubricant. The gland seal is a primary source of deposit formation in plunger or piston pumps where a suspended polymer liquid is pumped in the chamber that is integral with the packing gland seal.

The non-deposit-forming liquid can be any liquid that is compatible with the suspended polymer liquid. The non-deposit-forming liquid may have a viscosity greater than or less than the suspended polymer liquid that is being pumped. The higher viscosity will assist in laying down a coating on the elastomer and sliding metal surfaces that helps to exclude the suspended polymer liquid from these friction points. Most preferably, the non-deposit-forming liquid has lubricating properties that reduce erosion of the elastomer seals and extends maintenance intervals. Examples of preferred liquids are silicone oils with a viscosity in the range of 50 to 10,000 cPs, aqueous emulsions of said silicone oils, aqueous solutions of high molecular weight polyelectrolyte or polysaccharide polymers, aqueous solutions of high molecular weight natural or modified-natural polymers, and other aqueous compositions, alcohols, glycols, and glycerin.

An example liquid is polydimethylsiloxane oil (PDMS) with a viscosity between 50 and 10,000 cP. PDMS is compatible with the suspended polymer liquid, has good lubricating properties, is immiscible with the suspended polymer, and is available in several viscosity grades. Another example liquid is a 0.5% solution of acrylamide-sodium acrylate copolymer in water. The liquid can also be a water-ethylene glycol mixture or tap water.

Despite the best design, some polymer deposits and aggregates will likely form at the piston seal in the pump. To improve operability, it is useful to remove these aggregates from the suspended polymer liquid and non-deposit-forming liquid streams by filtration. Downstream from the pump but before the application point, the suspended polymer liquid may be passed through a filter to remove the deposits. Preferably, this filter would be contained within a housing that is capable of withstanding high pressures. Most preferably, the filter housing would be capable of withstanding 10,000 psi or greater pressure. The filter element may have any pore size below about 500 microns and be composed of any common filter material. Most preferably, the filter element is composed of smooth stainless steel wire screen with a pore size below 150 microns or a Mesh size of 100 or greater. It has been unexpectedly found that the deposits do not stick to smooth stainless steel wire screen and can be washed away by a periodic flushing of the filter housing with suspended polymer liquid to an external container. Most preferably, the external container would be a bag filter and housing that would collect the deposits and allow the suspended polymer liquid used for flushing to be recycled back to the beginning of the system.

During normal operation of the pumping apparatus, deposits would accumulate in the filter housing between the housing walls and the internal filter element. Periodically, a drain valve in the housing would be opened allowing the pumped suspended polymer liquid and accumulated deposits to divert to a secondary container. Most preferably, the secondary container is a low-pressure filter bag housing that would collect the deposits and allow the filtered suspended polymer liquid to recirculate back to the pump inlet or to a second filter bag housing prior to the pump inlet. The drain valve may be operated manually or in an automatic manner. Most preferably, the drain valve is operated by a pneumatic actuator that is controlled by an electrical solenoid that is further controlled by a cycle timer.

It was found that the polymeric deposits float in the suspended polymer liquid and that inverting the high-pressure filter housing with the drain valve at the top is the most preferred orientation. Deposits that enter the filter housing have a greater tendency to float past the filter element surface and collect near the drain at the top. This action assists in keeping the wire screen around the filter element free from deposits and prolongs the time required between filter element changes.

Backflushing of the high-pressure filter can also be accomplished with two 3-way valves on the inlet and outlet of the housing. The inlet valve can be turned to stop the flow of suspended polymer liquid and divert the suspended polymer liquid within the housing to a secondary container such as a bag filter. At the same time, the 3-way valve on the outlet can be turned to stop flow to the application and divert a flow of liquid backwards through the filter element, and out through the inlet port to the secondary container. This design is often used to backflush filter elements. In this case, the backflushing liquid may be the suspended polymer liquid itself or a second fluid such as water. The valve and piping design may also vary.

The non-deposit-forming lubricating liquid stream that is recirculated through the chamber that is integral with the packing gland can also be contaminated with polymer deposits that leak by the piston seal. These deposits may also be removed to improve operability by passing the outlet stream from the pump through a filter. Most preferably, this filter is a bag filter and housing that also acts as the reservoir for the non-deposit-forming liquid.

For the purposes of this application, “suspended polymer liquid” is defined as any immiscible mixture of polymer particles suspended in a liquid matrix. This includes oil-soluble polymers suspended in an aqueous or polar liquid and water-soluble polymers suspended in a hydrocarbon or non-polar liquid. Typically, a suspending aid is employed to keep the polymer particles from settling out too quickly or from aggregating. The polymer particle size is typically below 50-microns in diameter and most often below about 5-microns. The immiscible mixture may be made by any process including, but not limited to emulsion polymerization, dispersion polymerization, suspension polymerization, or precipitation polymerization. The mixture may also be made by grinding bulk-polymerized polymer and suspending the finely ground polymer in an immiscible liquid.

The suspended polymer liquid may comprise a polymer made from any monomer or combination of monomers. Non-limiting examples of monomers that may be formed into suspended polymers that would benefit from pumping using the present invention include alkyl acrylates, alkyl methacrylates, acrylic acid and its salts, methacrylic acid and its salts, ethylene and alpha olefins, vinyl acetate, vinyl pyrrolidone, vinyl caprolactam, vinyl chloride, mono- and dialkyl fumarates, mono- and dialkyl maleates, styrene, alkyl vinyl benzenes, vinylbenzene sulfonic acid and its salts, butadiene, isoprene, acrylonitrile, acrylamide, methacrylamide, acrylamide tert-butyl sulfonic acid and its salts, dimethylaminoethyl acrylate and its salts, acryloxyethyltrimethyl ammonium chloride, dimethylaminoethyl methacrylate and its salts, methacryloxyethyltrimethyl ammonium chloride, N-(3-(dimethylamino)propyl) methacrylamide and its salts, and 3-methacrylamidopropyl trimethylammonium chloride.

For the purposes of this application, “polymer” is defined as any combination of monomers polymerized in sufficient molecular weight to be solid or a hard gel. The suspended polymer liquid may be present either above or below its glass transition temperature and may optionally contain plasticizers and/or solvents.

The concept of separating the two chambers of the pump worked surprisingly well for this application. The pump modifications have effectively isolated the two chambers and eliminated deposit formation in the packing gland seal. The reduction in deposits and the effective filtration system will allow suspended polymer liquids to be applied commercially with minimal operational difficulties.

One aspect of the disclosure is directed to an apparatus for pumping suspended polymer liquid comprising a pump containing a separate non-deposit-forming liquid to exclude the suspended polymer liquid from contact with elastomeric sealing surfaces within the pump.

A separate non-deposit-forming liquid does not form deposits within the pump during normal operation and is compatible with the suspended polymer liquid. The separate non-deposit-forming liquid can also facilitate flow by reducing polymer deposits and improving the operability of the pumping system. The separate non-deposit-forming liquid can be immiscible with the suspended polymer liquid. The non-deposit-forming liquid can have a low viscosity relative to the internal phase polymer. The non-deposit-forming liquid can be consumed slowly in the course of excluding the suspended polymer liquid from contact with the sealing surfaces within the pump and becomes a component of the suspended polymer liquid.

The pump can employ a plunger and/or piston to provide the pumping action and has inlet and outlet check valves. The pump can have two pumping chambers that are connected by a cylinder inside which a piston reciprocates to provide the pumping action. The piston can be connected to a piston rod that reciprocates through a packing gland seal integral with one of the two pumping chambers. The chamber with the integral packing gland seal can contain only the non-deposit-forming liquid. The non-deposit-forming liquid is pumped from a reservoir, through the chamber of the pump that is integral with the packing gland seal, and back into the reservoir. A pressure control device can be situated between the outlet of the pump chamber that is integral with the packing gland seal and the reservoir. The pressure control device can be adjustable to allow the pressure within the pump chamber that is integral with the packing gland seal to be varied. The pressure control device can be a pressure relief valve with adjustable spring compression.

The suspended polymer liquid can be pumped through the chamber that is not integral with the packing gland seal. The piston can contain a U-Cup seal with the side containing the open channel or filled channel facing the chamber through which the suspended polymer liquid is pumped. The pressure of the non-deposit-forming liquid in the chamber integral with the packing gland seal can be adjusted with the pressure control device to adjust the leakage rate of this second liquid around the U-Cup seal. The piston can contain metal or inorganic seals in front of the U-Cup seal that directly contact the suspended polymer liquid. The metal or inorganic seals can be in the form of rings positioned within grooves in the piston and which are compressed inward when the piston is installed within the cylinder allowing the rings to ride tightly against the cylinder walls due to outward flexing of the rings.

The packing gland seal can be in contact with the non-deposit-forming liquid on the motor side of the seal and outside of the internal pump chamber. A chamber can be present on the backside of the packing gland seal that can hold the non-deposit-forming liquid in contact with the seal and plunger or piston rod as it reciprocates through the seal. The non-deposit-forming liquid can be pressurized within the chamber to force the liquid slowly through the seal and into the pump chamber. The pump can comprise inlet and outlet check valves that employ metal-on-metal sealing surfaces and do not contain elastomers in the sealing surfaces.

An inline filter can be employed after the pump to remove deposits from the suspended polymer liquid. The inline filter can be rated for pressure up to 20,000 psi. The inline filter can have an element comprising a wire screen wrapped smoothly around a cylindrical support to remove deposits from the suspended polymer liquid. The inline filter can contain a mechanism to flush accumulated deposits periodically to a second container. An inline filter can be employed in the recirculation loop of the non-deposit-forming liquid to remove deposits. An inline heat exchanger can be used to cool the suspended polymer liquid prior to entering the pump.

The non-deposit-forming liquid or non-deposit-forming liquid can have lubricating properties. The non-deposit-forming liquid can comprise a polydimethylsiloxane oil with a viscosity between 50 and 10,000 cPs at 23° C. The non-deposit-forming liquid can comprise an aqueous emulsion of a PDMS silicone oil with a polysiloxane viscosity between 50 and 10,000 cPs. The non-deposit-forming liquid can comprise a solution of a high molecular weight polyelectrolyte in water.

The high molecular weight polymers (e.g., polyelectrolytes and polysaccharides) described herein can have a weight average molecular weight of from about 1,000,000 Daltons to about 200,000,000 Daltons, from about 2,000,000 Daltons to about 200,000,000 Daltons, from about 3,000,000 Daltons to about 200,000,000 Daltons, from about 4,000,000 Daltons to about 200,000,000 Daltons, from about 5,000,000 Daltons to about 200,000,000 Daltons, from about 1,000,000 Daltons to about 100,000,000 Daltons, from about 2,000,000 Daltons to about 100,000,000 Daltons, from about 3,000,000 Daltons to about 100,000,000 Daltons, from about 4,000,000 Daltons to about 100,000,000 Daltons, from about 5,000,000 Daltons to about 100,000,000 Daltons, from about 1,000,000 Daltons to about 50,000,000 Daltons, from about 2,000,000 Daltons to about 50,000,000 Daltons, from about 3,000,000 Daltons to about 50,000,000 Daltons, from about 4,000,000 Daltons to about 50,000,000 Daltons, or from about 5,000,000 Daltons to about 50,000,000 Daltons.

Preferably, the weight average molecular weight of the high molecular weight polymers (e.g., polyelectrolytes and polysaccharides) is from about 5,000,000 Daltons to about 10,000,000 Daltons.

The non-deposit-forming liquid can comprise a solution of natural or modified polysaccharide in water. The non-deposit-forming liquid can be greater than 95% water. The non-deposit-forming liquid can comprise a pure or mixed hydrocarbon comprised primarily of carbon and hydrogen. The non-deposit-forming liquid can comprise polyether linkages. The non-deposit forming liquid can comprise polyethylene glycol, polypropylene glycol, polyglycerin, polybutylene glycol, a glycol copolymer, a glycol terpolymer, or a combination thereof. The non-deposit forming liquid can comprise an alcohol or glycol such as ethylene glycol. The non-deposit forming liquid can comprise glycerin.

The suspended polymer liquid, after leaving the pump, can be injected into a pipeline or conduit containing a flowing hydrocarbon fluid or water-based fluid. The suspended polymer liquid can be useful for reducing turbulence in the flowing liquid and thereby reduce friction and drag. The suspended polymer liquid can be transported through a long tube or umbilical before being injected into the pipeline or conduit.

As used in this application, including the appended claims, the singular forms “a,” “an,” and “the” include plural references unless the content clearly dictates otherwise, and are used interchangeably with “at least one” and “one or more.”

Unless otherwise defined, all technical and scientific terms used herein have the same meaning as commonly understood by one of ordinary skill in the art to which this disclosure pertains. Although methods and materials similar or equivalent to those described herein can be used, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

### EXAMPLES

It is to be understood that the preceding description is intended to illustrate and not limit the scope of the disclosure, which is defined by the scope of the appended claims. Other aspects, advantages, and modifications are within the scope of the following claims.

### Example 1

An unmodified CheckPoint 8412 pneumatic pump with a ¾″ cylinder bore that is rated for 12,000 psi pumping pressure was used to pump suspended polymer liquid containing 30% poly(2-ethylhexyl methacrylate) suspended in a water and ethylene glycol external phase. The pump inlet pulled suspended polymer liquid from a tote and through an inline bag filter. The outlet was plumbed through a high-pressure filter element and housing, then through a pressure relief valve to create backpressure, then back to the tote.

The unmodified 8412 pump was obtained with a stainless-steel piston that held a Kelrez slide ring seal activated with an internal O-ring. This was bracketed with two PEEK wear rings. The suspended polymer liquid was pumped at 6,000 psi for four hours at about 1 Liter per minute and the suspended polymer liquid was passed through a high-pressure filter to collect deposits. At the conclusion of the test, the suspended polymer liquid was drained from the high-pressure filter, collected on a pre-weighed filter screen, and washed with water and dried. About 6 grams of dark deposits were collected calculating to about 25 mg per Liter of suspended polymer liquid pumped. Then the pump was disassembled to view the cleanliness of the two chambers. Removal of the cylinder from the piston and shaft presented great difficulty because of binding of the piston due to sticky polymer deposits around the Kelrez seal. The front suspended polymer liquid chamber was mostly free of deposits and its outlet check valve was clean but the back chamber integral with the packing gland contained additional deposits in and around the packing gland. A significant amount of deposit was found outside of the packing gland that had passed through the seal (but was not collected). The outlet check valve for the chamber integral with the packing gland was partially fouled with deposits. The cylinder wall was badly scored on one side and the slide ring and wear rings were worn down on the same side. It is theorized that unsymmetrical deposit buildup on the opposite side of the piston forced the piston against the wall and caused the damage. It was decided that the 8412 pump was not suitable for pumping this suspended polymer liquid in its unmodified state.

Then the 8412 pump was modified by removing the common chemical inlet and exhaust manifolds. The chamber integral with the packing gland was plumbed to recirculate a non-deposit-forming lubricating fluid from a #4 filter bag and housing that served as a reservoir, to the pump inlet, and back through a spring-loaded pressure relief valve to the filter bag. The front chamber was plumbed to pull suspended polymer liquid from a tote through a bag filter and housing and through a heat exchanger to the pump inlet. The heat exchanger used the cold exhaust air from the pneumatic pump to cool the suspended polymer liquid by up to 10° C. before entering the pump. The check valves were modified by enlarging the holes in the floating poppet cartridge and by removing the fine springs to use only gravity for closure. The scored cylinder was replaced with a new one. The high-pressure filter housing was modified with a pneumatic-actuated ball valve on the drain port that fed into a #4 filter bag and housing for the purpose of periodic blowdown of deposits accumulated in the high-pressure filter housing. A cycle timer was used to open the pneumatic ball valve for 30 seconds every hour. The suspended polymer liquid filtrate from the blowdown filter was channeled back to the pump system inlet.

### Example 2

A brass piston was made for the modified pump to hold a hard polyurethane U-cup seal (UH20008 from GMORS). Behind the U-cup seal, the cylindrical piston measured 1″ in length and had an outside diameter about 0.002″ less than the diameter of the ¾″ cylinder bore. The hole down the length of the piston was threaded for the piston rod with the back 0.5″ of the threads being drilled out to allow the piston to sit further back on the rod. The seal was fitted onto a cylindrical projection at the front of the piston 0.5″ in diameter and 0.25″ in length. In front of the seal was placed 5 brass washers with 0.066″ in thickness (0.33″ total) machined to fit tightly onto the ⅜″ threaded rod and with outside diameters about 0.002″ less than the cylinder bore. In front of the washers were placed two hex nuts that were tightened together to lock the piston in place.

Water was selected as the lubricant for the back chamber. Suspended polymer liquid from Example 1 was pumped at 10,000 psi through the front chamber of the modified 8412 pump for 150 hours at about 1 Liter per minute and the suspended polymer liquid was passed through a high-pressure filter before passing through a pressure relief valve and back to the tote. This filter was flushed with suspended polymer liquid for 30 seconds every hour into a pre-weighed bag filter to collect deposits. At the conclusion of the test, the suspended polymer liquid was drained from the bag filter and it was washed with water and dried. The filter contained about 75 g of dried deposits which correlates to 8.7 mg/L of suspended polymer liquid pumped. The high-pressure filter was disassembled. The 100 Mesh stainless-steel wire screen was mostly free from deposits due to the hourly flush.

About one gallon of water was recirculated through the back chamber and through a pre-weighed bag filter. When dried, only 0.7 g of deposit was present in the bag. Then the pump check valves were disassembled to view their cleanliness. Both check valves were clean and no deposits were present. The pump was not disassembled but was used “as-is” for Example 3.

### Example 3

The pump system test was continued at 10,000 psi for another 168 hours of continuous operation without maintenance of the pump from the previous test. The high-pressure filter element was modified to contain a layer of 325-Mesh wire screen over a support layer of 100 Mesh wire screen.

At the conclusion of the test, the emulsion was drained from the blowdown filter bag and it was washed with water and dried. The filter contained about 35.93 g of dried deposits which correlates to 5.5 mg/L of emulsion pumped. The high-pressure filter was disassembled. About 60% of the 325 Mesh stainless-steel wire screen was covered with a fine white deposit. The recirculated water in the back chamber remained clear throughout the test.

### Example 4

The pump test from Example 2 and 3 was continued at 9,000 psi for another 96 hours using the same U-cup seal but the tap water in the back chamber was replaced with an 0.2% aqueous polyelectrolyte solution of anionic Flopam AN 945 SH with a viscosity of about 80 cP at 25° C. A pumping rate of 0.85 L/min and 30 strokes per minute was maintained. The high-pressure filter element contained a layer of 325-Mesh wire screen over a support layer of 100 Mesh wire screen.

At the conclusion of the test, the emulsion was drained from the blowdown filter bag and it was washed with water and dried. The filter contained 9.25 g of dried deposits which correlates to 1.9 mg of deposit per liter of emulsion pumped. The high-pressure filter was disassembled. About 5% of the 325 Mesh stainless-steel wire screen was covered with a fine white deposit. The recirculated aqueous polymer solution in the back chamber remained clear throughout the test.

### Example 5

The ¾″ piston cylinder of the modified pump was changed to one with a bore of 23 mm. The piston was changed to a 2-part brass piston. The leading section was 1″ long with a diameter of 22.9 mm and contained two 1 mm thick iron rings in grooves that compressed when inserted into the cylinder bore. The trailing piston section contained a U-cup seal on a hub that contacted the back of the first section to enclose the seal. Behind the seal and integral with the seal hub was a ¼″ long brass disk with a diameter of 22.9 mm. The high-pressure filter element contained a layer of 325-Mesh wire screen over a support layer of 100 Mesh wire screen.

The pressure relief valve was set to 3000 psi and the pump system test was run for 54 hours of continuous operation at 32 strokes and 1.4 Liters per minute. An 0.4% lubricating polyelectrolyte solution of anionic Flopam AN 945 VHM in tap water with 0.01% Nalco 7330 biocide was recirculated in the back chamber integral with the packing gland with no backpressure applied. The aqueous solution remained clear throughout the test with no emulsion leakage across the piston seals. When the test was complete, the tared blowdown filter bag was washed with water and dried. The weight increase of 9.57 g corresponds to a deposit formation rate of 2.1 mg per Liter of emulsion pumped.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and methods without departing from the scope of the invention, it is intended that all matter contained in the above description and shown in the accompanying drawings shall be interpreted as illustrative and not in a limiting sense.

1. A pump apparatus comprising a pump head, the pump head comprising
a cylinder having a piston disposed therein, wherein the piston separates the cylinder into a first volume and a second volume;
a rod connected to the piston and to a motor through packing seal;
a suspended polymer liquid inlet in fluid communication with the first volume of the cylinder;
a first inlet valve in the suspended polymer liquid inlet and upstream from the first volume capable of controlling the flow of a suspended polymer liquid into the first volume;
a suspended polymer liquid outlet in fluid communication with the first volume of the cylinder;
a first outlet valve in the suspended polymer liquid outlet capable of controlling the flow of the suspended polymer liquid;
a non-deposit-forming liquid inlet in fluid communication with the second volume of the cylinder;
a second inlet valve in the non-deposit-forming liquid inlet and upstream from the second volume capable of controlling the flow of the non-deposit-forming liquid into the second volume;
a non-deposit-forming liquid outlet in fluid communication with the second volume of the cylinder;
a second outlet valve in the non-deposit-forming liquid outlet capable of controlling the flow of the non-deposit-forming liquid;
wherein the non-deposit-forming liquid outlet is in fluid communication with the non-deposit-forming liquid inlet.

2. The pump apparatus of claim 1, wherein the pump head further comprises a suspended polymer liquid filter in the suspended polymer liquid outlet downstream from the first outlet valve.

3. The pump apparatus of claim 1, wherein the pump head further comprises a heat exchanger in the suspended polymer liquid inlet upstream from the first inlet valve.

4. The pump apparatus of claim 1, wherein the pump apparatus further comprises a suspended polymer liquid vessel in fluid communication with the suspended polymer liquid inlet and a non-deposit-forming liquid vessel in fluid communication with the non-deposit-forming liquid inlet.

5. The pump apparatus of claim 4, wherein the non-deposit-forming liquid vessel comprises a bag filter and housing.

6. The pump apparatus of claim 1, wherein the pump head further comprises a packing seal surrounding the rod and connected to the cylinder in the second volume.

7. The pump apparatus of claim 1, wherein the pump apparatus further comprises a pressure control device between the second outlet valve and the non-deposit-forming liquid vessel.

8. The pump apparatus of claim 7, wherein the piston comprises a U-cup seal and a side of the U-cup seal having an open channel or filled channel is in contact with the first volume of the cylinder.

9. The pump apparatus of claim 8, wherein the pressure control device is adjustable to allow the pressure within pump chamber that is integral with the packing seal to be varied and adjust the leakage rate of the non-deposit-forming liquid around the U-cup seal.

10. The pump apparatus of claim 9, wherein the piston contains metal or inorganic seals in front of the U-Cup seal that directly contact the suspended polymer liquid.

11. The pump apparatus of claim 2, wherein the suspended polymer liquid filter has an element comprising a wire screen wrapped smoothly around a cylindrical support to remove deposits from the suspended polymer liquid.

12. The pump apparatus of claim 1, wherein the non-deposit-forming liquid comprises an emulsion of polydimethylsiloxane oil.

13. The pump apparatus of claim 1, wherein the non-deposit-forming liquid comprises water, an alcohol, a glycol, a polyglycol, glycerin, a high molecular weight polyelectrolyte in water, or a combination thereof.

14. (canceled)

15. The pump apparatus of claim 1, wherein the non-deposit-forming liquid comprises a solution of natural or modified polysaccharide in water.

16. The pump apparatus of claim 1, wherein the non-deposit-forming liquid comprises a lipophilic compound with lubricating properties selected from a hydrocarbon oil, a fatty acid, a fatty ester, a fatty amide, a fatty alcohol, or a combination thereof.

17. The pump apparatus of claim 1, wherein the non-deposit-forming liquid comprises polyethylene glycol, polypropylene glycol, polyglycerin, polybutylene glycol, a glycol copolymer, a glycol terpolymer, or a combination thereof.

18. (canceled)

19. A method for pumping a suspended polymer liquid comprising
circulating a non-deposit-forming liquid from a liquid vessel through a liquid inlet and a second inlet valve to a second volume of a cylinder, out a liquid outlet through a second outlet valve and back to liquid inlet;
circulating a suspended polymer liquid from a suspended polymer liquid vessel through a suspended polymer liquid inlet through a first inlet valve into a first volume of the cylinder, out a suspended polymer liquid outlet through a first outlet valve and into a conduit comprising a flowing hydrocarbon fluid or flowing aqueous fluid;
moving the piston to change the relative volumes of the first volume and second volume in order to effect the circulation of the non-deposit-forming liquid and the suspended polymer liquid.

20.-22. (canceled)

23. The method of claim 19, wherein the suspended polymer liquid comprises a polymer derived from an alkylacrylate monomer, an alkylmethacrylate monomer, or a combination thereof.

24. The method of claim 23, wherein the suspended polymer liquid comprises a polymer derived from a 2-ethylhexylmethacrylate monomer.

25. The method of claim 19, wherein the suspended polymer liquid flows out the suspended polymer liquid outlet and flows into a first conduit and then the suspended polymer liquid is injected into a second conduit comprising the flowing hydrocarbon fluid or flowing aqueous fluid, wherein the first conduit is an umbilical line and wherein the polymer in the suspended polymer liquid disperses into the flowing hydrocarbon fluid or the flowing aqueous fluid and reduces turbulence, friction, or drag in the conduit or second conduit.

26.-27. (canceled)
